(19) United States
(12) Patent Application Publication
(10) Pub. No.: US 2025/0029127 A1
(43) Pub. Date: Jan. 23, 2025

(54) DEDUPLICATING ELECTRONIC SURVEY QUESTIONS UTILIZING MACHINE-LEARNING MODEL DOMAIN CLASSIFICATION

(71) Applicant: OneTrust LLC, Atlanta, GA (US)

(72) Inventors: Jonathan Blake Brannon, Smyrna, GA (US); Anil C Jagarlamudi, Atlanta, GA (US); Jason L Sabourin, Dewitt, MI (US)

(21) Appl. No.: 18/711,817

(22) PCT Filed: Jan. 30, 2023
(86) PCT No.: PCT/US23/61587

§ 371 Date: May 20, 2024

Related U.S. Application Data
(60) Provisional application No. 63/304,889, filed on Jan. 31, 2022.

(51) Int. Cl. G06Q 30/0203

(52) U.S. Cl. CPC G06Q 30/0203

(57) ABSTRACT

Methods, systems, and non-transitory computer readable storage media are disclosed for utilizing machine-learning models to deduplicate electronic survey questions of electronic surveys or questionnaires in real-time. Specifically, the disclosed system maps electronic survey questions to specific domain classifications by utilizing a machine-learning model to classify portions of electronic surveys based on context within the portions of the electronic surveys. Additionally, the disclosed system utilizes the mappings of electronic survey questions to domain classifications to determine whether to deduplicate specific questions that are semantically similar and within the same domain classifications. For instance, the disclosed system utilizes natural language processing to find semantically similar questions across a plurality of electronic surveys and deduplicate the similar questions if their domain classifications are the same.

### CROSS-REFERENCE TO RELATED APPLICATIONS

This application claims priority to U.S. Provisional Application No. 63/304,889, entitled “DEDUPLICATING ELECTRONIC SURVEY QUESTIONS UTILIZING MACHINE-LEARNING MODEL DOMAIN CLASSIFICATION,” filed Jul. 31, 2022, the full disclosure of which is incorporated herein by reference.

### BACKGROUND

Many entities that provide a product or service utilize electronic surveys to collect detailed information from recipients or potential recipients of the product or service. Specifically, the electronic surveys provide the entities with valuable information for improving the products and services for providing to the potential recipients. In some instances, the surveys provide the entities with necessary information for providing the services or products to customers, employees, or other service/product recipients. Administering electronic surveys utilizing computer software to provide to appropriate recipients in connection with providing services or products can include transmitting significant amounts of data to and from a large number of recipient devices. Accordingly, utilizing electronic surveys to obtain up-to-date information from potentially many recipients while ensuring the accuracy of response data and efficiently using computing resources is a challenging aspect of providing a product or service. Conventional systems typically utilize computing resources inefficiently and perform unnecessary computer processing by storing and transmitting duplicative data while limiting the generation/administration of survey content according to pre-defined ontologies. Furthermore, conventional system are often inflexible and rigid with respect to types of information and numbers of potential respondents of surveys.

### SUMMARY

This disclosure describes one or more embodiments of methods, non-transitory computer readable media, and systems that solve the foregoing problems (in addition to providing other benefits) by utilizing machine-learning models to deduplicate electronic survey questions of electronic surveys or questionnaires in real-time. Specifically, the disclosed systems map electronic survey questions to specific domain classifications by utilizing a machine-learning model to classify portions of electronic surveys based on context within the portions of the electronic surveys. Additionally, the disclosed systems utilize the mappings of electronic survey questions to domain classifications to determine whether to deduplicate specific questions that are semantically similar and within the same domain classifications. For instance, the disclosed systems utilize natural language processing to find semantically similar questions across a plurality of electronic surveys and deduplicate the similar questions in response to determining that their domain classifications are the same. The disclosed systems thus utilize one or more machine-learning models to flexibly and efficiently deduplicate electronic survey questions for a plurality of electronic surveys in real-time.

### BRIEF DESCRIPTION OF THE DRAWINGS

Various embodiments will be described and explained with additional specificity and detail through the use of the accompanying drawings in which:

FIG. 1 illustrates an example of a system environment in which a content deduplication system can operate in accordance with one or more embodiments.

FIG. 2 illustrates an example of an overview of the content deduplication system utilizing machine-learning to deduplicate electronic survey questions of electronic surveys in accordance with one or more embodiments.

FIG. 3 illustrates an example of the content deduplication system utilizing natural language processing to deduplicate electronic survey questions in accordance with one or more embodiments.

FIG. 4 illustrates an example of the content deduplication system utilizing responses and feedback for deduplicated electronic survey questions to train a machine-learning model in accordance with one or more embodiments.

FIG. 5 illustrates an example of the content deduplication system intelligently determines respondents for electronic survey questions in accordance with one or more embodiments.

FIG. 6 illustrates an example of the content deduplication system utilizing document data and response data to validate and recommend responses to electronic survey questions in accordance with one or more embodiments.

FIG. 7 illustrates an example of graphical user interface for presenting information associated with deduplicated electronic survey questions in an electronic survey in accordance with one or more embodiments.

FIG. 8 illustrates a flowchart of a series of acts of modifying an electronic survey by deduplicating electronic survey questions based on semantic similarities and domain classifications in accordance with one or more embodiments.

FIG. 9 illustrates an example of a computing device in accordance with one or more embodiments.

### DETAILED DESCRIPTION

This disclosure describes one or more embodiments of a content deduplication system that intelligently deduplicates electronic survey questions across electronic surveys in real-time. In one or more embodiments, the content deduplication system utilizes one or more machine-learning models to deduplication electronic survey questions based on their semantic content and similarity to other electronic survey questions. For example, the content deduplication system utilizes a classification machine-learning model to map portions of electronic surveys to domain classifications (e.g., to group electronic survey questions according to topic/category). The content deduplication system also utilizes natural language processing in connection with the domain classifications to determine whether to deduplicate similar electronic survey questions in one or more electronic surveys.

As mentioned, in one or more embodiments, the content deduplication system determines domain classifications for a plurality of electronic survey questions. Specifically, the content deduplication system utilizes one or more machine-learning models to classify portions of one or more electronic surveys (e.g., electronic survey templates) based on context provided within the portions. For instance, the content deduplication system determines a domain classification for a plurality of electronic survey questions within a given portion of an electronic survey. To illustrate, the content deduplication system determines a topic or category (e.g., physical security, informational security) to which one or more questions of an electronic survey relate. Accordingly, the content deduplication system determines a domain classification for each electronic survey question of a plurality of electronic survey questions across any number of electronic surveys.

In one or more embodiments, the content deduplication system also identifies similar electronic survey questions in one or more electronic surveys. For example, the content deduplication system utilizes a natural language processing model to determine similar electronic survey questions according to words and/or phrases included in the electronic survey questions. Furthermore, the content deduplication system utilizes the domain classifications of similar electronic survey questions to determine whether the electronic survey questions belong to the same domain.

In additional embodiments, the content deduplication system deduplicates one or more electronic surveys by removing one or more electronic survey questions from the electronic survey(s). In particular, in response to determining that similar electronic survey questions belong to the same domain, the content deduplication system removes one of the electronic survey questions from an electronic survey. The content deduplication system also provides a deduplicated set of electronic survey questions in an electronic survey to a respondent.

In some embodiments, the content deduplication system utilizes additional information associated with the electronic survey questions, respondents, or one or more entities to determine whether to deduplicate an electronic survey. To illustrate, the content deduplication system utilizes, but is not limited to, respondent information (e.g., titles), entity information (e.g., documents), historical survey data (e.g., previous response data), or answer data (e.g., answer format/type) to determine whether to remove a particular electronic survey question from an electronic survey for a particular respondent. The content deduplication system can similarly utilize such data to select a particular respondent (e.g., respondent device) for including a given electronic survey question within an electronic survey to the respondent. Furthermore, the content deduplication system can also utilize document data in connection with verifying and recommending responses to specific electronic survey questions of one or more electronic surveys.

As mentioned, conventional systems have a number of shortcomings in relation to generating and administering electronic surveys. For example, many conventional systems provide/utilize rigid electronic survey software applications that limit the generation and administration of electronic survey content by requiring pre-built ontologies/mappings of specific questions to specific topics to be provided to the software applications before administering electronic surveys. In particular, these conventional systems utilize software applications that rely on manually or statically generated electronic survey questions ontologies (e.g., based on user-defined survey content and behavior provided to the software applications prior to administering the electronic surveys to respondent devices). Accordingly, such conventional systems are unable to dynamically modify or generate electronic survey content during administration of electronic surveys or based on previously administered electronic survey content.

Additionally, because survey response data is most useful with a greater number of data points (e.g., more responses), some conventional systems provide a general survey to a large audience or an audience of multiple different demographics (i.e., a “one-survey-fits-all” approach) to obtain a large dataset of response information. The one-survey-fits-all approach of conventional systems, however, is inflexible. For example, the generic inflexibility of conventional systems leads to longer survey administration times, response data that is useless or irrelevant to respondents, and results in excessive and useless response data. This also leads to further increases in the amount of processing and networking resources of administrator devices and/or respondent devices due to large target audiences of electronic surveys.

The lack of flexibility of the conventional systems also results in response data that is less useful or misleading. As mentioned, by providing electronic survey questions to respondents for which the questions are irrelevant or with long administration times, some respondents either end the surveys early or provide bad answers (e.g., by lying or not paying attention to the questions). Thus, the conventional systems can receive misleading response data that does not accurately reflect the true sentiment of the respondents. Incomplete or misleading response data takes up additional computing resources without providing any benefit, especially when dealing with large amounts of response data, making it difficult to filter and find useful response data.

Additionally, while conventional systems often provide tools for administering electronic surveys based on survey templates, individually generated surveys often include unnecessary electronic survey questions or electronic survey questions that overlap with other electronic surveys. To illustrate, an entity, or different groups within the entity, generate electronic surveys (e.g., questionnaires) to provide to different groups of respondents to obtain specific types of information in one or more topic domains. The conventional systems typically administer the electronic surveys to the groups of respondents based on administrator instructions (e.g., based on the different administrator groups) without filtering or modifying the electronic surveys. As an example, entities often administer electronic surveys by providing a survey (or a link to the survey) via email, and administering a set of static questions to a respondent device. Administering such redundant and unnecessary electronic surveys via these conventional systems can result in additional storage space for the electronic surveys and response data, as well as increased communication resources and bandwidth for administering the electronic surveys.

The disclosed content deduplication system provides a number of advantages over conventional systems. For example, the content deduplication system provides flexibility for computing systems that manage and administer electronic surveys by intelligently deduplicating and routing electronic survey questions based on context information. In particular, in contrast to conventional systems that rigidly administer electronic surveys according to generated electronic surveys, the content deduplication system utilizes machine-learning models to determine the usefulness of electronic survey questions in real-time. To illustrate, by utilizing machine-learning models to classify portions of electronic surveys according to specific domain classifications and natural language processing to identify similar electronic survey questions, the content deduplication system removes unnecessary electronic survey questions from electronic surveys in real-time, even if administered by different groups. In some instances, the content deduplication system also modifies electronic survey questions in additional surveys by auto-populating responses to semantically similar questions with similar domain classifications based on response data for previously administered electronic survey questions, thereby reducing response time and response data for later respondents.

Furthermore, the content deduplication system also improves the functionality of computing systems managing electronic surveys. Specifically, in contrast to conventional systems that rely on pre-built ontologies, the content deduplication system utilizes machine-learning to automatically and dynamically deduplicate electronic survey questions based on their semantic content and domain classifications in real-time. For instance, the content deduplication system finds similar electronic survey questions to electronic survey questions being administered to one or more respondents to determine whether to deduplicate (e.g., hide) one or more questions from the respondent(s) during administration of an electronic survey based on the corresponding domain classifications. The content deduplication system thus provides electronic survey content without presenting redundant electronic survey questions, which results in less response data transmitted and processed in connection with administering electronic surveys, especially when administering electronic surveys to a large number of respondent devices. Additionally, dynamically populating/generating electronic survey content according to mappings generated in real-time during administration of electronic surveys provides improved navigation of relevant information for respondents. Deduplicated electronic surveys accordingly reduce the administration and response time associated with the electronic surveys by dynamically eliminating unnecessary/duplicative survey content or dynamically populating electronic survey content via real-time machine-learning analysis of electronic survey content.

Furthermore, the content deduplication system improves the efficiency and accuracy of computing systems administering electronic surveys and respondent devices displaying electronic surveys by leveraging existing data to automatically populate and verify electronic survey questions. Specifically, by utilizing machine-learning to determine semantic meaning and domain classifications of electronic survey questions in connection with domain classification and content analysis of existing digital documents utilizing machine-learning models, the content deduplication system provides relevant and easily accessible information to respondents and administrators. For instance, the content deduplication system automatically determines document data that allows respondents to quickly complete electronic surveys and administrators to quickly verify response data based on automatically populated/deduplicated electronic survey content. More specifically, the content deduplication system improves efficiency and accuracy by presenting relevant information in tandem with electronic survey questions or response data (e.g., within a single interface or by providing navigation shortcuts/links to document data processed by the machine-learning models).

In addition, the content deduplication system also provides improved accuracy of computing systems administering electronic surveys. In particular, by utilizing machine-learning models to deduplicate electronic surveys via real-time machine-learning analysis of survey content based on both semantic content/meaning and domain classifications of electronic survey questions, the content deduplication system provides dynamic administration of electronic surveys with shorter administration times and more focused questions. For example, the content deduplication system leverages the real-time analysis of survey content utilizing machine-learning models to determine whether to populate or hide specific electronic survey questions within a particular electronic survey (e.g., for display within a graphical user interface of a respondent device). Accordingly, the content deduplication system can streamline/tailor the information (e.g., electronic survey questions and/or supporting document data) for display at a respondent device to present and obtain the most relevant information while administering a particular electronic survey. Shorter and more focused electronic surveys lead to more accurate and relevant response data indicative of respondent sentiment, resulting in obtaining the most relevant data for processing. Thus, in contrast to conventional systems that often receive misleading response data, the content deduplication system improves the quality of the response data while also reducing the amount of irrelevant response data (and therefore, reducing unnecessary use of computing resources to process inaccurate data).

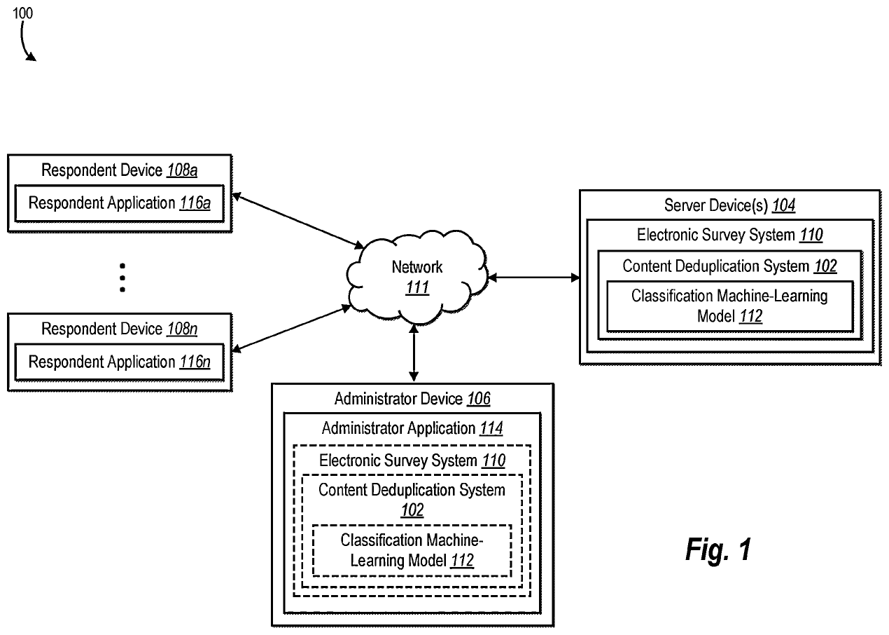

Turning now to the figures, FIG. 1 includes an embodiment of a system environment 100 in which an content deduplication system 102 is implemented. In particular, the system environment 100 includes server device(s) 104, an administrator device 106, and respondent devices 108a-108n in communication via a network 111. Moreover, as shown, the server device(s) 104 include an electronic survey system 110, which includes the content deduplication system 102. As further illustrate in FIG. 1, the content deduplication system 102 includes a classification machine-learning model 112. Furthermore, the administrator device 106 includes an administrator application 114, and the respondent devices 108a-108n include respondent applications 116a-116n. Additionally, the administrator application 114 optionally includes the electronic survey system 110 and the content deduplication system 102, which further includes the classification machine-learning model 112.

As shown in FIG. 1, in one or more implementations, the server device(s) 104 includes or hosts the electronic survey system 110. Specifically, the electronic survey system 110 includes, or is part of, one or more systems that implement electronic survey management. For example, the electronic survey system 110 provides tools for generating, viewing, or otherwise interacting with electronic surveys. To illustrate, the electronic survey system 110 communicates with the administrator device 106 via the network 111 to provide the tools for display and interaction via the administrator application 114 at the administrator device 106. Additionally, in some embodiments, the electronic survey system 110 receives data from the administrator device 106 in connection with managing electronic surveys for one or more entities, including requests to perform operations based on digital content stored at the server device(s) 104 (or at another device such as a source repository) and/or requests to store digital content from the administrator device 106 at the server device(s) 104 (or at another device). In some embodiments, the electronic survey system 110 receives interaction data for generating or viewing electronic surveys or response data based on digital content at the administrator device 106, processes the interaction data (e.g., to generate or edit electronic surveys), and provides the results of the interaction data to the administrator device 106 for display via the administrator application 114 or to a third-party system.

In one or more embodiments, the electronic survey system 110 provides tools for generating and administering an electronic survey for an entity. In particular, the electronic survey system 110 provides tools (e.g., via the administrator application 114) for selecting, viewing, generating, or administering an electronic survey. The electronic survey system 110 can also provide tools for selecting or viewing response data associated with an electronic survey. Additionally, the electronic survey system 110 utilizes the content deduplication system 102 to intelligently deduplicate electronic surveys based on semantic similarities between electronic survey questions and their respective domain classifications. Specifically, the content deduplication system 102 utilizes the classification machine-learning model 112 to determine domain classifications for electronic survey questions based on contextual information for the electronic survey questions. The content deduplication system 102 deduplicates similar electronic survey questions (e.g., questions with similar semantic meaning, elicit the same/similar responses, and/or have the same purpose) based on the domain classifications (e.g., by removing one or more electronic survey questions). In some embodiments, the content deduplication system 102 utilizes one or more additional machine-learning models such as natural language processing models to deduplicate electronic survey questions.

In one or more embodiments, after the content deduplication system 102 deduplicates electronic survey questions of one or more electronic surveys, the electronic survey system 110 provides the one or more electronic surveys to one or more of the respondent devices 108a-108n. For instance, the electronic survey system 110 sends the electronic surveys to the respondent devices 108a-108n for display within the respondent applications 116a-116n. Additionally, the respondent devices 108a-108n provide response data including responses to the electronic surveys via the network 111 to the server device(s) 104.

In additional embodiments, the electronic survey system 110 provides deduplicated electronic surveys to the administrator device 106. In particular, the electronic survey system 110 provides the deduplicated electronic surveys for display within the administrator application 114 at the administrator device 106. The administrator device 106 displays the deduplicated electronic surveys for viewing (or other interactions) by an administrator associated with the administrator device 106. In some embodiments, the administrator device 106 also provides additional interaction data to the electronic survey system 110 (or the content deduplication system 102) for further improving the deduplicated electronic surveys. The content deduplication system 102 utilizes such information to improve the performance of the classification machine-learning model 112, such as by utilizing the interaction data to further train the classification machine-learning model 112.

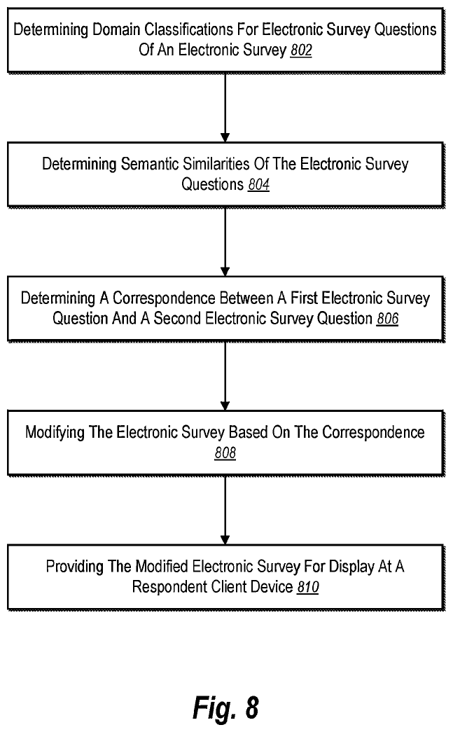

In one or more embodiments, the server device(s) 104 include a variety of computing devices, including those described below with reference to FIG. 8. For example, the server device(s) 104 includes one or more servers for storing and processing data associated with generating or administering electronic surveys for one or more entities. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the administrator device 106 and the respondent devices 108a-108n. In one or more embodiments, the administrator device 106 and/or the respondent devices 108a-108n include, but are not limited to, a mobile device (e.g., smartphone or tablet), a laptop, a desktop, including those explained below with reference to FIG. 8. Furthermore, although not shown in FIG. 1, the administrator device 106 and respondent devices 108a-108n can be operated by users (e.g., a user included in, or associated with, the system environment 100) to perform a variety of functions. In particular, the administrator device 106 and respondent devices 108a-108n performs functions such as, but not limited to, accessing, viewing, and interacting with digital content (e.g., electronic surveys). In some embodiments, the administrator device 106 also performs functions for generating, capturing, or accessing data to provide to the electronic survey system 110 and the content deduplication system 102 in connection with electronic survey management. For example, the administrator device 106 communicates with the server device(s) 104 via the network 111 to provide information (e.g., user interactions) associated with generating electronic surveys and deduplicating electronic surveys. Although FIG. 1 illustrates the system environment 100 with a single administrator device 106, in some embodiments, the system environment 100 includes a different number of administrator devices.

Additionally, as shown in FIG. 1, the system environment 100 includes the network 111. The network 111 enables communication between components of the system environment 100. In one or more embodiments, the network 111 may include the Internet or World Wide Web. Additionally, the network 111 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104, the administrator device 106, and the respondent devices 108a-108n communicate via the network using one or more communication platforms and technologies suitable for transporting data and/or communication signals, including any known communication technologies, devices, media, and protocols supportive of data communications, examples of which are described with reference to FIG. 8.

Although FIG. 1 illustrates the server device(s) 104, the administrator device 106, and the respondent devices 108a-108n communicating via the network 111, in alternative embodiments, the various components of the system environment 100 communicate and/or interact via other methods (e.g., the server device(s) 104, the administrator device 106, and/or the respondent devices 108a-108n can communicate directly). Furthermore, although FIG. 1 illustrates the content deduplication system 102 being implemented by a particular component and/or device within the system environment 100, the content deduplication system 102 and/or the electronic survey system 110 can be implemented, in whole or in part, by other computing devices and/or components in the system environment 100 (e.g., the administrator device 106).

In particular, in some implementations, the content deduplication system 102 (or the electronic survey system 110) on the server device(s) 104 supports the content deduplication system 102 on the administrator device 106. For instance, the content deduplication system 102 on the server device(s) 104 generates or trains the content deduplication system 102 (e.g., the classification machine-learning model 112) for the administrator device 106. The server device(s) 104 provides the generated/trained content deduplication system 102 to the administrator device 106. In other words, the administrator device 106 obtains (e.g., downloads) the content deduplication system 102 from the server device(s) 104. At this point, the administrator device 106 is able to utilize the content deduplication system 102 to generate and deduplicate electronic surveys independently from the server device(s) 104.

In alternative embodiments, the content deduplication system 102 includes a web hosting application that allows the administrator device 106 to interact with content and services hosted on the server device(s) 104. To illustrate, in one or more implementations, the administrator device 106 accesses a web page supported by the server device(s) 104. The administrator device 106 provides input to the server device(s) 104 to perform electronic survey deduplication operations, and, in response, the content deduplication system 102 or the electronic survey system 110 on the server device(s) 104 performs operations to deduplicate electronic surveys. The server device(s) 104 provide the output or results of the operations to the administrator device 106 and/or the respondent devices 108a-108n.

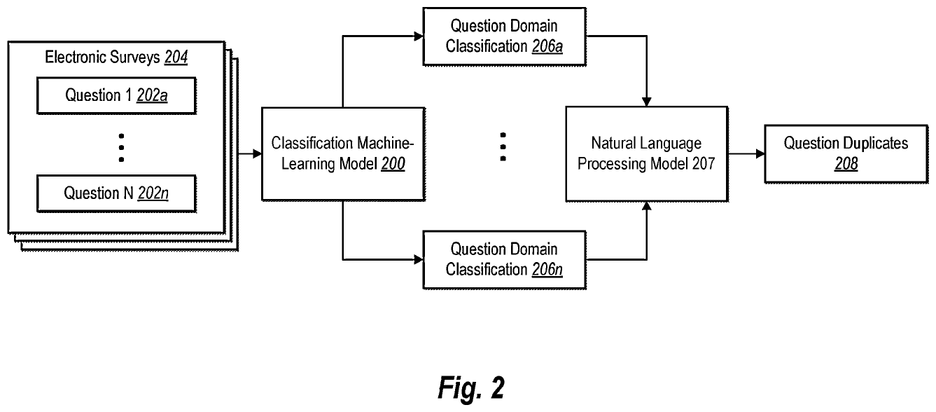

As mentioned, the content deduplication system 102 deduplicates electronic surveys by utilizing one or more machine-learning models to classify based on contextual information associated with electronic survey questions. FIG. 2 illustrates an overview of the content deduplication system 102 processing electronic survey questions for a plurality of electronic surveys to remove or modify duplicate questions. Specifically, the content deduplication system 102 utilizes a classification machine-learning model 200 to classify a plurality of electronic questions 202a-202n of a plurality of electronic surveys 204 into a plurality of question domain classifications 206a-206n. The content deduplication system 102 removes or modifies (e.g., by auto-populating response data) question duplicates 208 based on the question domain classifications 206a-206n.

In one or more embodiments, the content deduplication system 102 accesses the electronic survey questions 202a-202n in the electronic surveys 204 in connection with administering the electronic surveys 204 to one or more respondent devices. For example, the content deduplication system 102 accesses the electronic surveys 204 from a database of electronic surveys. In some embodiments, the content deduplication system 102 accesses the electronic surveys 204 during administration of the electronic surveys 204 to one or more respondent devices. Additionally, the content deduplication system 102 determines the electronic survey questions 202a-202n from the electronic surveys 204 or from portions of the electronic surveys 204.

According to one or more embodiments, the content deduplication system 102 utilizes the classification machine-learning model 200 to determine the question domain classifications 206a-206n of the electronic survey questions 202a-202n. In particular, the classification machine-learning model 200 determines sections of the electronic surveys 204 including related contextual information. The classification machine-learning model 200 determines domain classifications for electronic survey questions within each section and assigns the question domain classifications 206a-206n accordingly.

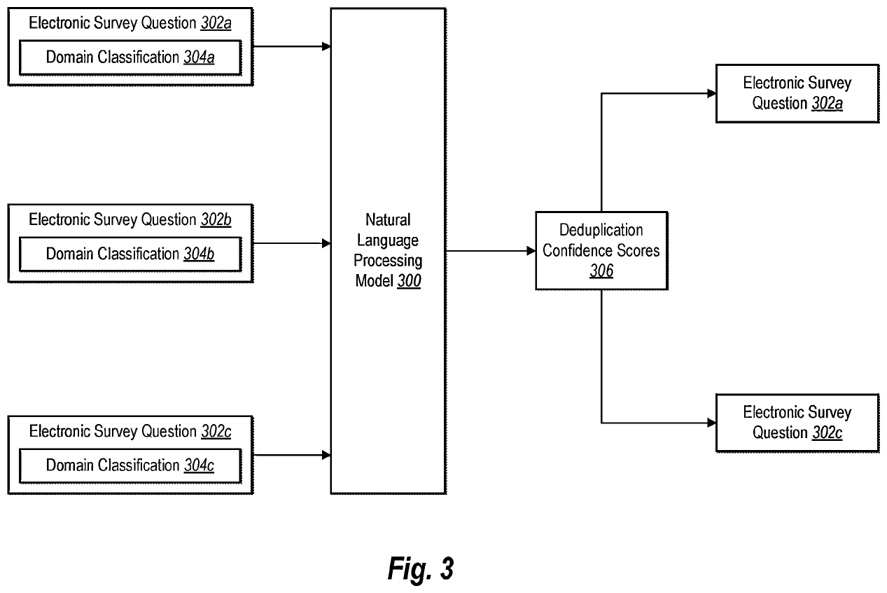

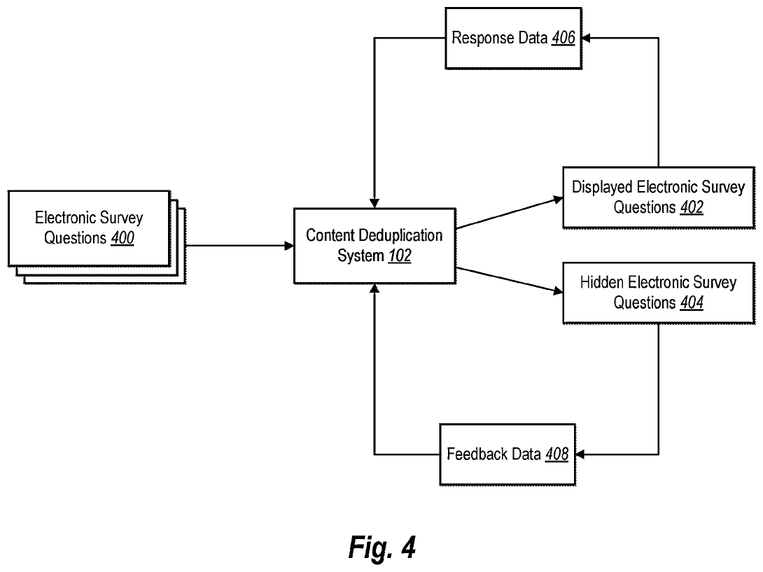

As illustrated in FIG. 2, the content deduplication system 102 determines the question duplicates 208 based on the question domain classifications 206a-206n and natural language processing via a natural language processing model 207. For example, as described in FIG. 3, the content deduplication system 102 utilizes the natural language processing model 207 to determine similar electronic survey questions across one or more electronic surveys based on natural language processing of the electronic survey questions. The content deduplication system 102 deduplicates similar questions based on the question domain classifications 206a-206n and semantic similarity. Additionally, as described in more detail with respect to FIGS. 4-6, the content deduplication system 102 utilizes additional information associated with electronic surveys, response data, entities, and respondents to refine/improve deduplication of electronic surveys. Additionally, although FIG. 2 illustrates that the natural language processing model 207 is positioned after the classification machine-learning model 200, in alternative embodiments, the natural language processing model 207 is positioned before the classification machine-learning model 200.

According to one or more embodiments, an electronic survey (or survey) includes an electronic communication used to collect information. For example, the term survey includes an electronic communication in the form of a poll, questionnaire, census, or other type of sampling. To illustrate, an electronic survey could include an electronic communication with one or more electronic survey questions based on information requested by an entity. Further, an electronic survey generally includes a method of requesting and collecting electronic data from respondents via an electronic communication distribution channel. In some embodiments, an electronic survey includes a template including one or more electronic survey questions that are adaptable for generating one or more different electronic surveys. An electronic survey can also be reproduced in non-electronic form (e.g., by printing the electronic survey for respondents to complete in paper form). Additionally, in one or more embodiments, a respondent refers to a person or entity that participates in or responds to a survey. Furthermore, in one or more embodiments, an administrator includes to a person or entity that creates or causes the administration of a survey.

In one or more embodiments, an electronic survey question includes a prompt within a survey to invoke a response from a respondent. For example, an electronic survey question includes one of many different types of questions, including, but not limited to, perception, multiple choice, open-ended, ranking, scoring, summation, demographic, dichotomous, differential, cumulative, dropdown, matrix, single textbox, heat map, and any other type of prompt that can invoke a response from a respondent. In additional examples, an electronic survey question includes a prompt portion as well as an available answer portion that corresponds to the survey question.

According to one or more embodiments, a response includes electronic data a respondent provides with respect to an electronic survey question. The electronic data can include content and/or feedback from the respondent in response to a survey question. Depending on the question type, the response includes, but is not limited to, a selection, a text input, an indication of an answer selection, a user provided answer, an unstructured response, and/or an attachment.

Furthermore, in one or more embodiments, an entity includes a person, a group of people, or an organization associated with a person or group of people. For example, an entity includes a single individual such as, but not limited to, an owner, manager, employee, or customer. Alternatively, an entity includes a business, association, or other organized body of people.

In one or more embodiments, the content deduplication system 102 utilizes automation via one or more machine-learning models to deduplicate electronic survey questions of electronic surveys based on their semantic content. For example, the content deduplication system 102 determines that an electronic survey includes multiple questions that are similarly worded (or otherwise have the same or similar semantic content) and that are also classified as belonging to the same domain (e.g., information security). Specifically, the content deduplication system 102 determines whether words/phrases with semantically similar content have the same or similar meaning, even if worded or structured differently. To illustrate, “Which access controls are used for compliance with infosec policies?” and “Please list access controls used by your organization to enforce the information security policy identified above,” can have the same semantic meaning for eliciting the same or similar responses in the same domain (i.e., information security) even though the questions are phrased differently. Accordingly, the content deduplication system determines a correspondence between a first question of an electronic survey and at least one other question of one or more electronic surveys if the questions are semantically similar and have the same domain classification. The content deduplication system 102 thus determines to deduplicate the similarly worded questions by removing one of the questions.

In additional examples, the content deduplication system 102 determines that an electronic survey includes multiple questions that are similarly worded (or otherwise have the same or similar semantic content), but that are classified as belonging to different domains (e.g., information security and physical security). The content deduplication system 102 thus determines not to deduplicate the questions because the questions belong to different domains. To illustrate, although “What is your access control process?” and “Describe your access control process,” have similar semantic meaning, the requests can have different domains (e.g., physical security and information security) based on the surrounding context. For instance, a request for information on “access controls” used by an organization may elicit different responses with respect to information security (e.g., access controls such as passwords and multi-factor authentication) and physical security (e.g., access controls such as padlocks and check-ins with security personnel). Additionally, the content deduplication system 102 also determines to present similarly worded questions in different domains to different respondents (e.g., an infosec officer and a physical security officer), rather than deduplicating the questions. In some embodiments, the content deduplication system 102 utilizes one or more machine-learning models to generate recommendations of one or more respondents for one or more electronic survey questions.

In one or more embodiments, a machine-learning model includes a computer representation that is tuned (e.g., trained) based on inputs to approximate unknown functions. For instance, a machine-learning model includes one or more machine-learning layers, neural network layers, or artificial neurons that approximate unknown functions by analyzing known data at different levels of abstraction. In some embodiments, a machine-learning model includes one or more machine-learning layers or neural network layers including, but not limited to, a k-nearest neighbors model, a support vector machines model, a conditional random field model, a maximum entropy model, a deep learning model, a convolutional neural network, a transformer neural network, a recurrent neural network, a fully-connected neural network, or a combination of a plurality of machine-learning models, neural networks, and/or neural network types. Additionally, a first machine-learning model (or machine-learning layers) for classifying domains of content can include a first type of machine-learning model, and a second machine-learning model for natural language processing can include a second type of machine-learning model (or machine-learning layers).

According to one or more embodiments, the content deduplication system 102 utilizes a machine-learning model in combination with a set of rules to extract natural language information from electronic surveys. To illustrate, the content deduplication system 102 utilizes a matrix to parse portions of electronic surveys and extract intentions (e.g., intender, intendee, and intent). Additionally, the content deduplication system 102 can utilize machine-learning to train various models for different types of intent. The content deduplication system 102 can also utilize whitelisting or blacklisting for certain words. The content deduplication system 102 can thus utilize a multilayered approach to obtain improved accuracy for processing natural language portions of electronic questions.

According to one or more embodiments, the content deduplication system 102 utilizes a plurality of machine-learning models to perform operations of classifying and deduplicating electronic survey questions of an electronic survey. For instance, the content deduplication system 102 utilizes a first machine-learning model to group electronic survey questions into domain classifications (e.g., by determining a first group of questions into information security questions and a second group of questions into physical security questions). Additionally, the content deduplication system 102 utilizes a second machine-learning model to process each group within the different domain classifications to deduplicate semantically similar questions within the groups.

To illustrate, the content deduplication system 102 utilizes a first machine-learning model (e.g., a convolutional neural network) to encode different sections and/or electronic survey questions of one or more electronic surveys into feature vectors. The content deduplication system 102 applies a k-nearest neighbor model to divide the feature vectors into a plurality of segments corresponding to domain classifications (e.g., information security, physical security). In some instances, the content deduplication system 102 divides the sections into different segments (e.g., based on the k-nearest neighbor analysis and with or without applying domain labels to the sections).

After segmenting the sections of the electronic survey(s) into different groups, the content deduplication system 102 deduplicates portions based on the segmentation. For instance, the content deduplication system 102 determines whether each segment includes more than one section/electronic survey question. If a segment includes more than one section/question, the content deduplication system 102 utilizes a natural language processing model to identify and deduplicate semantically similar sections/questions within the segment. If a segment does not include more than one section/question, the content deduplication system 102 determines not to deduplicate the segment.

For example, as shown in the tables below, the content deduplication system 102 processes a plurality of assessments including different sections, each including one or more electronic survey questions.

Assessment 1

| | |
|---|---|
| Section 1 | Q1 |
| | Q2 |
| Section 2 | Q3 |
| | Q4 |
| | Q5 |
| Section 3 | Q6 |
| | Q7 |

Assessment 2

| | |
|---|---|
| Section 1 | Q1 |
| | Q2 |
| | Q3 |
| | Q4 |
| Section 2 | Q5 |
| | Q6 |
| Section 3 | Q7 |
| | Q8 |

The content deduplication system 102 groups the sections of the assessments by domain. To illustrate, the content deduplication system 102 segments the above assessments as shown below:
Group 1: Section 1 (Assessment 1), Section 3 (Assessment 2)
Group 2: Section 3 (Assessment 1), Section 2 (Assessment 2)
Group 3: Section 2 (Assessment 1)
Group 4: Section 1 (Assessment 2)

The content deduplication system 102 selects questions from Group 1 and Group 2 for further deduplication analysis (e.g., utilizing natural language processing to determine whether each group includes duplicative questions). The content deduplication system 102 determines that Group 3 and Group 4 do not need additional deduplication analysis.

In additional embodiments, the content deduplication system 102 utilizes a first machine-learning model to group questions according to semantic similarity (e.g., via natural language processing). For example, the content deduplication system 102 utilizes the first machine-learning model to group questions that include a variant of “What are your access control procedures?” based on their semantic similarity. The content deduplication system 102 utilizes a second machine-learning model to determine domain classifications for semantically similar questions and deduplicate semantically similar questions within the same domain classification. In such cases, if the content deduplication system 102 determines that one or more questions have no semantically similar questions in any electronic surveys, the content deduplication system 102 does not utilize the second machine-learning model to determine a domain classification for the question.

For instance, the content deduplication system 102 utilizes a first machine-learning model including a natural language processing model to perform semantic analysis on each section/question in an electronic survey. For example, the content deduplication system 102 encodes a plurality of electronic survey questions into a plurality of feature vectors. The content deduplication system 102 determines similar pairs of questions based on their distances in the feature space. In one or more embodiments, the content deduplication system 102 utilizes natural language processing to extract, from an electronic survey question, a set of predictions that include one or more of a subject, an object, and an intention of the electronic survey question.

In response to determining that two or more electronic survey questions are within a threshold proximity of each other in the feature space, the content deduplication system 102 determines whether the semantically similar questions are in the same domain. To illustrate, the content deduplication system 102 utilizes a second machine-learning model to classify the semantically similar questions based on context information associated with the questions. For example, the content deduplication system 102 utilizes the second machine-learning model to generate a domain classification by applying the second machine-learning model to the subject, object, and intention extracted from the electronic survey question. The second machine-learning model predicts a domain classification of the question or otherwise indicates the domain based on the extracted data (e.g., by encoding the electronic survey question into a vector space indicating the domain classification). The content deduplication system 102 deduplicates two or more of the electronic survey questions if the semantically similar questions also have the same domain classification. By first performing natural language processing on the questions, the content deduplication system 102 can avoid performing the domain classification for questions that are not semantically similar to other questions.

In some embodiments, the content deduplication system 102 utilizes a single machine-learning model to determine semantic similarity and domain similarity of electronic survey questions. For instance, the content deduplication system 102 utilizes the machine-learning model to determine groups of semantically similar electronic survey questions and groups of electronic survey questions having the same domain classifications. In such embodiments, the machine-learning model may determine the semantic groupings and domain similarities simultaneously or in any order. To illustrate, the content deduplication system 1012 utilizes a single machine-learning model to encode each question in an electronic survey and context information associated with the question (e.g., surrounding portion of the electronic survey) into a feature vector. The resulting feature vectors can represent both the semantic meaning and domain of the question, which the content deduplication system 102 can use to deduplicate similar questions.

In one or more embodiments, the content deduplication system 102 utilizes a machine-learning model configured for domain classification to determine a semantic meaning for an electronic survey question. For instance, the content deduplication system 102 utilizes the machine-learning model to extract a subject, an object, and an intention from an electronic survey question. The machine-learning model also predicts a semantic meaning of the electronic survey question or otherwise indicates the semantic meaning based on the extracted data. To illustrate, the machine-learning model encodes the electronic survey question into a vector space indicating a semantic meaning in connection with a domain of the electronic survey question.

In further embodiments, the content deduplication system 102 utilizes user input to verify domain classifications or semantic classifications of electronic survey questions. For example, the content deduplication system 102 receives user input indicating confirmation of, or correction to, an electronic survey question based on the outputs of the machine-learning model(s).

In one or more embodiments, the content deduplication system 102 utilizes one or more machine-learning models to classify documents (e.g., unstructured data from various data sources) according to certain standards, regulations, or frameworks found in one or more electronic surveys. In one or more embodiments, the content deduplication system 102 utilizes the classification of the documents to select specific documents in connection with responding to, or responses for, an electronic survey. To illustrate, in response to determining that a set of emails is classified as being relevant to a security control framework, the content deduplication system 102 selects the set of emails for use in completing or verifying an electronic survey question belonging to a domain associated with the security control framework. For instance, the content deduplication system 102 provides a respondent with access to the emails, auto-populates an answer to the electronic survey question utilizing the emails, or validates a respondent's answer to the electronic survey question based on content of the emails.

By utilizing machine-learning models to determine domain classifications of content in electronic surveys, the content deduplication system 102 determines related portions of electronic surveys without relying on pre-built ontologies. Specifically, the content deduplication system 102 is able to determine that two electronic survey questions are related (e.g., within the same domain) even in the absence of an existing ontology mapping questions from one electronic survey to other electronic surveys. The content deduplication system 102 is thus able to determine whether to deduplicate electronic survey questions across any number of electronic surveys based on the surrounding context and semantic similarity.

As mentioned, the content deduplication system 102 deduplicates electronic surveys based on semantic content and domain classifications of electronic survey questions. In one or more embodiments, the content deduplication system 102 identifies a plurality of different survey templates-a first template for cybersecurity (e.g., a questionnaire corresponding to the National Institute of Standards and Technology (“NIST”)), and a second template for privacy (e.g., a questionnaire corresponding to the General Data Protection Regulation (“GDPR”)). The content deduplication system 102 determines that each template includes sets of questions representing different domains of topics for collecting information via the template. For example, the content deduplication system 102 determines that a first section includes questions for employment practices and a second section for data encryption and transfer practices. The content deduplication system 102 deduplicates the templates based on domain classifications assigned to the different sections and presents a deduplicated set of questions to one or more respondents.

FIG. 3 illustrates the content deduplication system 102 deduplicating a set of electronic survey questions according to classifications of questions mapped to specific domains by utilizing a natural language processing model 300. Specifically, the content deduplication system 102 utilizes the mapping of electronic survey questions within an electronic survey to specific domain classifications to determine whether two or more questions are intended to collect the same (or similar) information. The content deduplication system 102 utilizes the natural language processing model 300 to perform semantic natural language processing search techniques on a plurality of electronic survey questions 302a-302c. As illustrated in FIG. 3, the content deduplication system 102 determines domain classifications 304a-304c based on the previously determined mappings.

Additionally, in some embodiments, the content deduplication system 102 utilizes the natural language processing model 300 to determine semantic meanings for the electronic survey questions 302a-302c based on the domain classifications 304a-304c. For example, an electronic survey question such as “Do you have access policies?” can have a first semantic meaning in a first domain (e.g., access control such as padlocks and ID checks in the context of physical security) and a second semantic meaning in a second domain (e.g., access control such as password strength requirements in the context of information security). While the questions appear identical, the context for each question is different (e.g., based on surrounding information related to the questions such as in specific sections of an electronic survey including the questions). Additionally, the content deduplication system 102 can determine that two differently worded questions in the same domain have the same semantic meaning.

Accordingly, in one or more embodiments, the content deduplication system 102 determines whether to deduplicate a particular electronic survey question based on the surrounding context. As illustrated in FIG. 3, the content deduplication system 102 utilizes the natural language processing model 300 to generate deduplication confidence scores 306 for the electronic survey questions 302a-302c. To illustrate, the content deduplication system 102 generates a deduplication confidence score for each pair of electronic survey questions indicating a confidence that the two questions are semantically similar (or dissimilar). For example, the content deduplication system 102 generates a first deduplication confidence score for a first electronic survey question 302a and a second electronic survey question 302b utilizing the natural language processing model 300, a first domain classification 304a of the first electronic survey question 302a, and a second domain classification 304b of the second electronic survey question 302b. As in the example above, the content deduplication system 102 determines a confidence score of 75% that two questions including “Do you have access policies?” should not be deduplicated for two different domains related to physical security and information security.

To illustrate, as shown in FIG. 3, the content deduplication system 102 determines to deduplicate the second electronic survey question 302b based on a deduplication confidence score associated with the second electronic survey question 302b. For example, the content deduplication system 102 determines that the deduplication confidence score involving the second electronic survey question 302b and the first electronic survey question 302a does not meet a threshold. Accordingly, the content deduplication system 102 removes the second electronic survey question 302b from an electronic survey administered to a respondent. Although FIG. 3 illustrates removing the second electronic survey question 302b, the content deduplication system 102 may alternatively remove the first electronic survey question 302a based on the shared deduplication confidence score. Additionally, the content deduplication system 102 determines not to deduplicate a third electronic survey question 302c based on the deduplication confidence scores 306.

Although FIG. 3 illustrates that the natural language processing model 300 generates the deduplication confidence scores 306, in alternative embodiments, a separate machine-learning model generates deduplication confidence scores. For example, as mentioned, the content deduplication system 102 can utilize a natural language processing model to determine semantic similarities of electronic questions prior to determining corresponding domain classifications. Accordingly, the machine-learning model that determines the domain classifications can also generate the deduplication confidence scores. In additional examples, a single machine-learning model determines domain classifications, semantic similarities, and deduplication confidence scores. In further embodiments, the content deduplication system 102 utilizes an additional machine-learning model positioned after one or more machine-learning models that determine the domain classifications and semantic similarities to generate deduplication confidence scores.

In additional embodiments, the content deduplication system 102 modifies an electronic survey question of an electronic survey based on similar electronic survey questions in one or more other electronic surveys. For example, rather than removing an electronic survey question from an electronic survey after determining that a first electronic survey question is semantically similar to, and belongs to the same domain as, a second electronic survey question, the content deduplication system accesses data associated with the second electronic survey question for use with the first electronic survey question. To illustrate, the content deduplication system obtains response data from the second electronic survey question in a previously administered electronic survey and auto-populates response data for the first electronic survey question. The content deduplication system also presents the auto-populated response data for display at a respondent device for verification and/or additional modification.

By utilizing natural language processing to analyze the semantic content of electronic survey questions and determine the surrounding context, the content deduplication system 102 is able to automatically modify electronic surveys. In particular, determining whether an electronic survey question is duplicative can be a combination of the text of the electronic survey question and a category/topic associated with the question (e.g., a domain of the question). The content deduplication system 102 combines the analysis of the natural language processing results and the domain classification to determine whether to deduplicate two or more electronic survey questions.

In one or more embodiments, the content deduplication system 102 utilizes feedback or other information associated with generating and administering electronic surveys to improve the performance of one or more machine-learning models involved in the deduplication process. FIG. 4 illustrates that the content deduplication system 102 processes electronic survey questions 400 for one or more electronic surveys. In particular, the content deduplication system 102 determines a set of displayed electronic survey questions 402 and a set of hidden electronic survey questions 404 by deduplicating the electronic survey questions 400 according to context and domain information for the electronic survey questions 400. For example, the displayed electronic survey questions 402 include questions that the content deduplication system 102 determined not to deduplicate. Additionally, the hidden electronic survey questions 404 include questions that the content deduplication system 102 determined to deduplicate.

According to one or more embodiments, the content deduplication system 102 receives response data 406 in connection with administering the displayed electronic survey questions 402 to one or more respondents. For example, the content deduplication system 102 provides the displayed electronic survey questions 402 for display at one or more respondent client devices. The respondent client devices send the response data 406 to the content deduplication system 102 including responses by the respondent(s) to the displayed electronic survey questions 402. The content deduplication system 102 utilizes the response data 406 to determine questions that certain respondents do not answer (e.g., the response data lacks a response for a particular question) and further train the machine-learning models to accurately classify and/or deduplicate such questions when administering subsequent electronic surveys. To illustrate, the content deduplication system 102 determines a loss based on the lack of response data for a question and modifies parameters of one or more machine-learning models based on the lack of response data for the question.

Additionally, in one or more embodiments, the content deduplication system 102 utilizes historical response data to determine domain classifications for specific electronic survey questions. For instance, the content deduplication system 102 determines that a certain electronic survey question is frequently associated with response data indicating a specific domain classification (e.g., responses often include answers indicating physical security measures) in a first electronic survey. The content deduplication system 102 also determines that the electronic survey question is frequently associated with response data indicating a separate domain classification (e.g., responses often include answers indicating informational security measures). The content deduplication system 102 thus trains the classification machine-learning model to classify the electronic survey question differently based on the electronic survey. Accordingly, the content deduplication system 102 determines not to deduplicate the electronic survey question in different electronic surveys based on the different domain classifications based on the historical response data.

In additional embodiments, the content deduplication system 102 receives feedback data 408 in connection with deduplicating the hidden electronic survey questions 404. Specifically, the content deduplication system 102 provides an indication of one or more deduplicated electronic survey questions to an administrator to verify the accuracy of the deduplication process for the deduplicated electronic survey questions. For example, the administrator (e.g., via an administrator device) displays information associated with the hidden electronic survey questions 404 (e.g., a list of hidden questions). The content deduplication system 102 receives the feedback data 408 including information indicating that one or more of the deduplicating determinations was incorrect (e.g., the administrator can dispute one or more deduplicated questions by indicating that a deduplicated question was incorrectly deduplicated). The content deduplication system 102 utilizes the feedback data 408 to further train the machine-learning models to more accurately determine whether to deduplicate electronic survey questions when administering subsequent electronic surveys.

In one or more embodiments, the content deduplication system 102 also utilizes additional information associated with electronic survey questions to determine whether to deduplicate electronic survey questions. For instance, the content deduplication system 102 determines formats or other data associated with answer portions of electronic survey questions to determine whether to deduplicate the electronic survey questions. To illustrate, if similarly worded questions include answers of different types (e.g., a checkbox answer and a narrative text field), the content deduplication system 102 determines not to deduplicate the questions. Specifically, the content deduplication system 102 utilizes a classification machine-learning model to generate different domain classifications for such electronic survey questions.

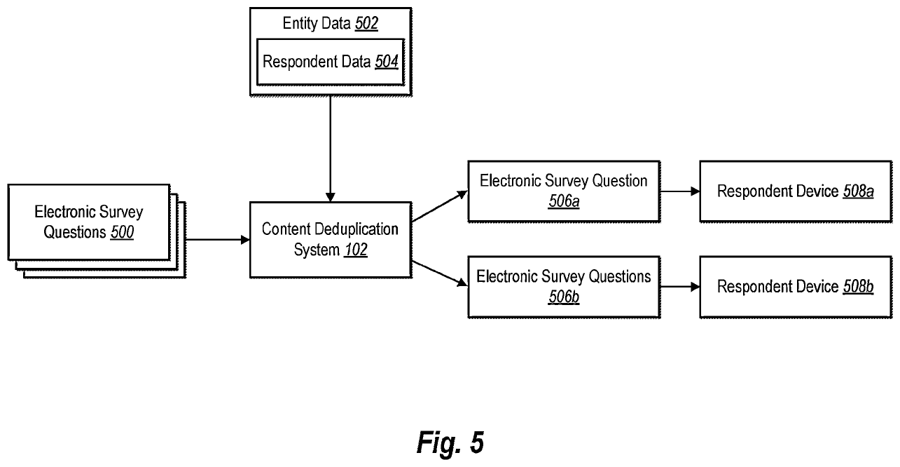

As mentioned, in one or more embodiments, the content deduplication system 102 utilizes domain classifications of electronic survey content to select respondents for specific electronic survey questions in electronic surveys. FIG. 5 illustrates that the content deduplication system 102 utilizes information associated with an entity and/or respondents to determine whether to provide specific questions to specific respondents. Accordingly, the content deduplication system 102 intelligently determines whether to deduplicate and/or re-route electronic survey questions from an electronic survey during administration of the electronic survey.

As illustrated in FIG. 5, the content deduplication system 102 processes a plurality of electronic survey questions 500 according to entity data 502 associated with an entity. In one or more embodiments, the entity data 502 includes respondent data 504 of respondents corresponding to the entity. To illustrate, the respondents include different people in different departments of the entity (e.g., a first person in a physical security department and a second person in an information security department). The content deduplication system 102 utilizes a machine-learning model to classify the electronic survey questions into different respondent classifications based on the respondent data 504 (e.g., based on roles of the respondents in connection with the entity). For instance, the content deduplication system 102 utilizes a machine-learning model trained on tags, titles, role, commonly assigned tasks, organizational charts, or other descriptive information of respondents to determine respondent classifications and assign the respondent classifications to electronic survey questions.

For instance, the content deduplication system 102 applies a first respondent classification to a first electronic survey question 506a based on the content of the first electronic survey question 506a. In some embodiments, the content deduplication system 102 utilizes an existing domain classification of the first electronic survey question 506a (e.g., based on the context information within an electronic survey including the first electronic survey question 506a) to determine the first respondent classification. To illustrate, the content deduplication system 102 determines that the first respondent includes a classification as a “compliance officer” question. Accordingly, the content deduplication system 102 assigns the first respondent classification to the first electronic survey question 506a and routes (or provides a suggestion to route) the first electronic survey question 506a to a first respondent device 508a based on the first respondent classification.

Additionally, as illustrated in FIG. 5, the content deduplication system 102 routes (or provides a suggestion to route) a second electronic survey question 506b to a second respondent device 508b. In particular, the content deduplication system 102 determines a second respondent classification for the second electronic survey question 506b based on the respondent data 504 and content of the second electronic survey question 506b. To illustrate, the content deduplication system 102 determines that the second electronic survey question 506b is classified into a second respondent corresponding to a “privacy officer” role within the entity. The content deduplication system 102 thus routes the second electronic survey question 506b to the second respondent device 508b based on the second respondent device 508b corresponding to a respondent in the privacy officer role.

In an additional example, the content deduplication system 102 determines that a first potential respondent has a title of “chief intellectual property officer,” and a second potential respondent has a title of “corporate paralegal.” The content deduplication system 102 also determines that an electronic survey question has a respondent classification corresponding to “intellectual property paralegals” (e.g., common respondents to the electronic survey question). Accordingly, the content deduplication system 102 generates a recommendation to route the electronic survey question (or automatically routes the electronic survey question) to the corporate paralegal based on the respective titles of the potential respondents and the respondent classification of the electronic survey question.

In additional embodiments, the content deduplication system 102 applies a plurality of classifications to one or more electronic survey questions. For example, the content deduplication system 102 first determines a domain classification for a particular electronic survey question based on the semantic content and context associated with the electronic survey question. The content deduplication system 102 also determines a respondent classification for the electronic survey question based on the content of the electronic survey question, the domain classification, and/or respondent data. In some embodiments, the content deduplication system 102 also determines domain classifications and/or respondent classifications to one or more electronic surveys and/or electronic survey questions within the electronic surveys. The content deduplication system 102 thus utilizes a plurality of classifications for electronic surveys and/or electronic survey questions to determine whether to deduplicate electronic survey questions and/or route electronic survey questions to particular respondent devices.

In one or more embodiments, the content deduplication system 102 trains a machine-learning model based on a training dataset including content corresponding to a set of domain classifications. To illustrate, the content deduplication system 102 provides electronic surveys tagged with ground-truth domain classifications to the machine-learning model and learns parameters of the machine-learning model based on differences between predicted domain classifications and the ground-truth domain classifications. In some embodiments, the content deduplication system 102 trains separate machine-learning models for domain classification and respondent classifications and/or for each entity.

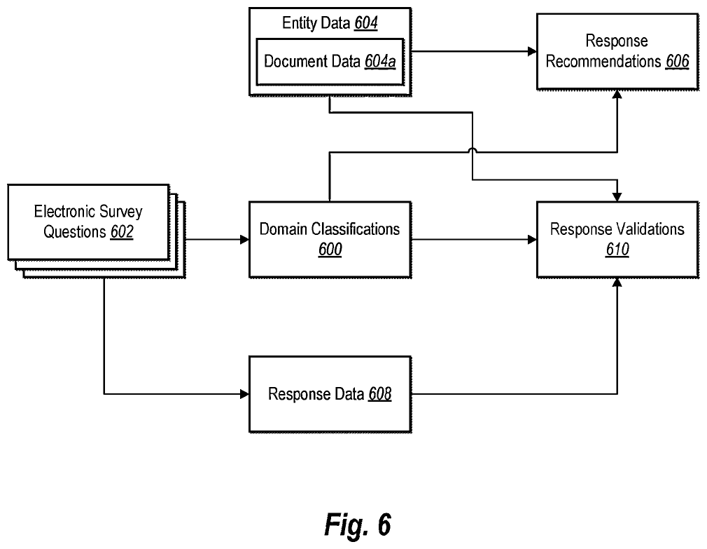

FIG. 6 illustrates that the content deduplication system 102 utilizes existing documents associated with an entity to provide additional information in connection with administering electronic surveys. For instance, the content deduplication system 102 utilizes existing documents to determine whether to assist in completing electronic surveys. The content deduplication system 102 can also utilize existing documents to verify responses to electronic survey questions in electronic surveys.

For example, the content deduplication system 102 determines domain classifications 600 for a plurality of electronic survey questions 602. In one or more embodiments, the content deduplication system 102 also determines entity data 604 including document data 604a (e.g., documents or portions of documents) for an entity. In particular, the content deduplication system 102 determines stored documents (e.g., spreadsheets, text-based documents, PDFs, webpages, emails) for the entity in connection with one or more electronic surveys administered to one or more respondents associated with the entity. To illustrate, the content deduplication system 102 accesses emails, design specifications, invoices, policy documents, legal documents, or other documents associated with an entity. For instance, the content deduplication system 102 receives the documents in one or more requests for domain classification or automatically obtains the documents from a database of documents. The content deduplication system 102 analyzes, categorizes, and indexes the document data 604a for the documents to determine whether certain documents are relevant to specific electronic survey questions (e.g., based on the domain classifications 600).

In one or more embodiments, the content deduplication system 102 classifies the document data 604a to generate a data inventory according to the domain classifications 600. Specifically, the content deduplication system 102 utilizes one or more machine-learning models to calculate confidence scores for a document (or portion of a document) with respect to the domain classifications 600. The content deduplication system 102 determines whether each document or portion of a document corresponds to a particular domain classification based on the confidence scores. For example, the content deduplication system 102 utilizes a natural language processing model to determine semantic content (e.g., based on words or phrases) from the document or portion of the document for assigning a domain classification to the document or portion of the document. In some embodiments, the content deduplication system 102 also utilizes video or audio processing to analyze video or audio content.

In one or more embodiments, the content deduplication system 102 processes the document data 604a to determine structured objects (e.g., predefined objects) or unstructured objects (e.g., text, audio, video) from the document data 604a and classifies the structured objects utilizing one or more machine-learning models. The content deduplication system 102 classifies documents or portions of documents based on the structured objects and/or unstructured objects. To illustrate, the content deduplication system 102 utilizes contextual information, sentiment, and/or syntax to classify the objects. The content deduplication system 102 can also utilize one or more machine-learning models to determine relationships between objects within the document data 604a and provide information regarding the relationships (e.g., cross-reference indicators). Additionally, in one or more embodiments, the content deduplication system 102 determines relevant or irrelevant portions of documents and marks the respective portions as relevant or irrelevant.

In one or more embodiments, the content deduplication system 102 provides response recommendations 606 for the electronic survey questions 602 based on the document data 604a. For example, in response to determining that a given document is relevant to a particular electronic survey question in an electronic survey, the content deduplication system 102 generates a response recommendation based on the document and the electronic survey question. To illustrate, the content deduplication system 102 provides the document (or a link to the document) to a respondent in connection with administering the electronic survey question. The respondent can interact with a respondent device to access the document and view the content of the document. Alternatively, the content deduplication system 102 auto-populates the electronic survey question with information from the relevant document.

Furthermore, in one or more embodiments, the content deduplication system 102 validates response data 608 for the electronic survey questions 602 utilizing the document data 604a. Specifically, the content deduplication system 102 utilizes existing documents of the entity to generate response validations 610 indicating whether one or more responses to the electronic survey questions 602 are correct. In particular, the content deduplication system 102 utilizes the domain classifications 600 of the electronic survey questions 602 to determine documents related to an electronic survey question (e.g., based on classifications of the documents). The content deduplication system 102 utilizes the relevant documents to verify the response data for the electronic survey question.

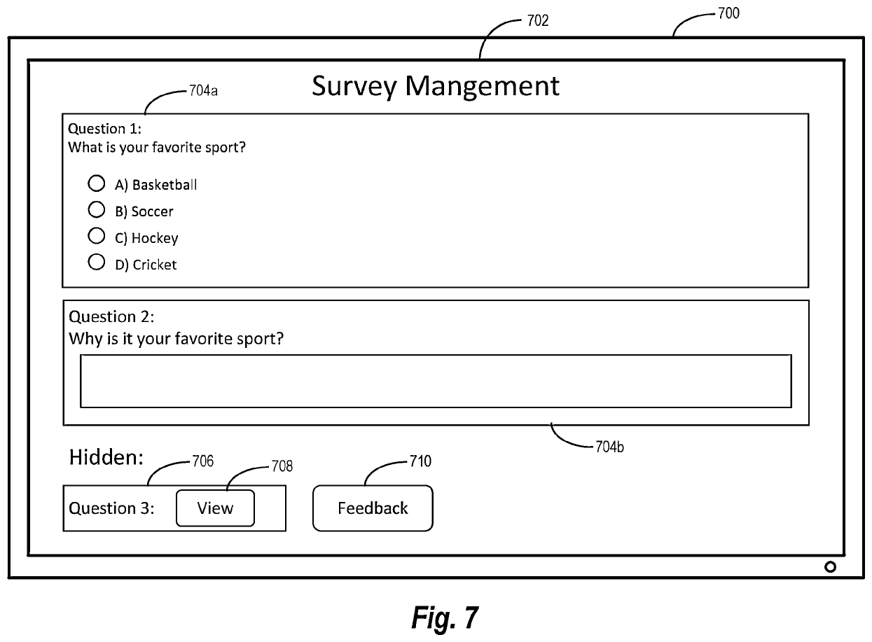

FIG. 7 illustrates a graphical user interface of a client device 700 including a client application 702. For example, the client device 700 includes an administrator device associated with an administrator of an electronic survey via an administrator application. FIG. 7 illustrates that the content deduplication system 102 provides survey management information associated with an electronic survey for verifying and providing feedback related to a deduplicated electronic survey. Specifically, the client device 700 displays a plurality of survey questions 704a-704b administered (e.g., displayed to a respondent) as part of an electronic survey.

In addition, FIG. 7 illustrates that the client device 700 displays one or more deduplicated electronic survey questions in connection with administering the electronic survey. For example, the client device 700 displays a hidden electronic survey question 706 (e.g., within a list of deduplicated questions). In addition, the client device 700 displays a question detail element 708 to view additional information associated with the hidden electronic survey question 706 (e.g., to view the question, domain classification, or similar questions determined by the content deduplication system 102). Furthermore, the client device 700 displays a feedback element 710 for providing feedback indicating that the content deduplication system 102 incorrectly marked the hidden electronic survey question 706 for deduplication. The content deduplication system 102 utilizes the feedback to improve the deduplication process (e.g., by further training a classification machine-learning model).

Turning now to FIG. 8, this figure shows a flowchart of a series of acts 800 of modifying an electronic survey by deduplicating electronic survey questions based on semantic similarities and domain classifications. While FIG. 8 illustrates acts according to one embodiment, alternative embodiments may omit, add to, reorder, and/or modify any of the acts shown in FIG. 8. The acts of FIG. 8 are part of a method. Alternatively, a non-transitory computer readable medium comprises instructions, that when executed by one or more processors, cause the one or more processors to perform the acts of FIG. 8. In still further embodiments, a system includes a processor or server configured to perform the acts of FIG. 8.

As shown, the series of acts 800 includes an act 802 of determining domain classifications for electronic survey questions of an electronic survey. For example, act 802 involves determining, utilizing one or more machine-learning models, a plurality of domain classifications for a plurality of electronic survey questions in one or more electronic surveys. Act 802 can involve utilizing a classification machine-learning model to determine the domain classifications.

Act 802 involves generating, utilizing a machine-learning model, a first classification indicating the domain classification for the first electronic survey question and the second electronic survey question according to a first topic. For example, act 802 can involve determining that the first electronic survey question is mapped to the domain classification from a first electronic survey. Act 802 can also involve determining that the second electronic survey question is mapped to the domain classification from a second electronic survey. Act 802 can also involve generating, utilizing the machine-learning model, a second classification indicating an additional domain classification for a third electronic survey question of the one or more electronic surveys according to a second topic.

Act 802 can involve generating, utilizing the one or more machine-learning models, a classification indicating that the first electronic survey question and the second electronic survey question are mapped to the domain classification in response to determining that the first electronic survey question and the second electronic survey question correspond to a topic of the domain classification.

In one or more embodiments, act 802 involves mapping, utilizing the classification machine-learning model, the first electronic survey question to the domain classification based on semantic content of the first electronic survey question. Act 802 can involve mapping, utilizing the classification machine-learning model, the second electronic survey question to the domain classification based on semantic content of the second electronic survey question.

The series of acts 800 also includes an act 804 of determining semantic similarities of the electronic survey questions. For example, act 804 involves determining, utilizing the one or more machine-learning models, semantic similarities of the plurality of electronic survey questions. Act 804 can involve determining, utilizing a natural language processing model, semantic meanings of the plurality of electronic survey questions according to words or phrases in the plurality of electronic survey questions.

Act 804 can involve determining, utilizing a natural language processing model, that the first electronic survey question and the second electronic survey question comprise semantically similar content based on words or phrases included in the first electronic survey question and the second electronic survey question. For example, act 804 can involve determining, utilizing the natural language processing model, that the first electronic survey question and the second electronic survey question comprise the semantically similar content in response to determining that the first electronic survey question and the second electronic survey question are mapped the domain classification.

In one or more embodiments, act 802 above involves determining, utilizing the machine-learning model, that the first electronic survey question and the second electronic survey question are mapped to the domain classification in response to determining that the first electronic survey question and the second electronic survey question comprise the semantically similar content.

Additionally, the series of acts 800 includes an act 806 of determining a correspondence between a first electronic survey question and a second electronic survey question. For example, act 806 involves determining, based on the semantic similarities of the plurality of electronic survey questions, a correspondence between a first electronic survey question of the one or more electronic surveys mapped to a domain classification and a second electronic survey question of the one or more electronic surveys mapped to the domain classification.

Act 806 can also involve determining the correspondence in response to the first electronic survey question and the second electronic survey question comprising the semantically similar content and being mapped to the domain classification. Act 806 can involve determining the correspondence between the first electronic survey question and the second electronic survey question in response to determining that the first electronic survey question and the second electronic survey question are mapped to the domain classification and have a similar semantic meaning.

Act 806 can involve determining that the first electronic survey question and the second electronic survey question comprise similar semantic meanings. Act 806 can also involve determining the correspondence between the first electronic survey question and the second electronic survey question in response to determining that the first electronic survey question and the second electronic survey question comprise similar semantic meanings and are mapped to the domain classification.

Act 806 can involve generating a deduplication confidence score for the first electronic survey question and the second electronic survey question based on the domain classification and semantic similarities between the first electronic survey question and the second electronic survey question. Act 806 can also involve determining the correspondence between the first electronic survey question and the second electronic survey question based on the deduplication confidence score.

The series of acts 800 further includes an act 808 of modifying the electronic survey based on the correspondence. For example, act 808 involves, responsive to a selection of an electronic survey of the one or more electronic surveys, modify the electronic survey based on the correspondence between the first electronic survey question and the second electronic survey question.

Act 808 can involve selecting the first electronic survey question to include in the modified electronic survey in response to determining that the first electronic survey question and the second electronic survey question are mapped to the domain classification and comprise the semantically similar content. Act 808 can involve removing the second electronic survey question from the one or more electronic surveys in response to determining that the first electronic survey question and the second electronic survey question are mapped to the domain classification and comprise the semantically similar content.

The series of acts 800 also includes an act 810 of providing the modified electronic survey for display at a respondent client device. For example, act 810 can involve providing the first electronic survey question with the modified electronic survey and excluding the second electronic survey question from the modified electronic survey. Act 810 can involve providing the modified electronic device to the respondent client devices to elicit responses to a set of electronic survey questions comprising the first electronic survey question in the modified electronic survey. Act 810 can also involve receiving response data from the respondent client devices including responses to the set of electronic survey questions in the modified electronic survey.

The series of acts 800 can include receiving response data from one or more client devices in response to the modified electronic survey. The series of acts 800 can also include determining that the response data lacks a response to an electronic survey question of the modified electronic survey. Additionally, the series of acts 800 can include determining a loss based on the response data lacking the response to the electronic survey question. The series of acts 800 can further include modifying parameters of the one or more machine-learning models to classify the electronic survey question based on the loss.

The series of acts 800 can include receiving response data from a plurality of client devices in response to the modified electronic survey. The series of acts 800 can also include determining that an electronic survey question mapped to a first domain classification by the one or more machine-learning models is associated with a second domain classification based on the response data. Additionally, the series of acts 800 can include modifying parameters of the one or more machine-learning models to map the electronic survey question to the second domain classification.

The series of acts 800 can include providing, for display at an administrator client device, an indication of a deduplicated electronic survey question corresponding to the modified electronic survey. The series of acts 800 can include receiving, from the administrator client device, feedback data indicating that the deduplicated electronic survey question was incorrectly deduplicated. Additionally, the series of acts 800 can include modifying parameters of the one or more machine-learning models based on the feedback data.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

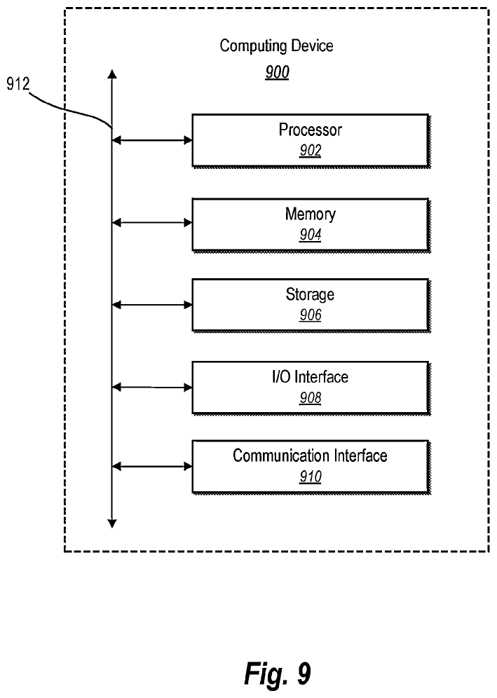

FIG. 9 illustrates a block diagram of exemplary computing device 900 that may be configured to perform one or more of the processes described above. One will appreciate that one or more computing devices such as the computing device 900 may implement the system(s) of FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. In certain embodiments, the computing device 900 can include fewer or more components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions for dynamically modifying workflows, the processor 902 may retrieve (or fetch) the instructions from an internal register, an internal cache, the memory 904, or the storage device 906 and decode and execute them. The memory 904 may be a volatile or non-volatile memory used for storing data, metadata, and programs for execution by the processor(s). The storage device 906 includes storage, such as a hard disk, flash disk drive, or other digital storage device, for storing data or instructions for performing the methods described herein.

The I/O interface 908 allows a user to provide input to, receive output from, and otherwise transfer data to and receive data from computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 910 may facilitate communications with various types of wired or wireless networks. The communication interface 910 may also facilitate communications using various communication protocols. The communication infrastructure 912 may also include hardware, software, or both that couples components of the computing device 900 to each other. For example, the communication interface 910 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, by at least one processor utilizing a machine-learning model, a plurality of domain classifications for a plurality of electronic survey questions in one or more electronic surveys;
determining, by the at least one processor and based on semantic content for the plurality of electronic survey questions, a correspondence between a first electronic survey question of the one or more electronic surveys mapped to a domain classification and a second electronic survey question of the one or more electronic surveys mapped to the domain classification;
responsive to a selection of an electronic survey of the one or more electronic surveys, modifying the electronic survey based on the correspondence between the first electronic survey question and the second electronic survey question; and
providing the modified electronic survey for display at a respondent client device.

2. The computer-implemented method of claim 1, wherein determining the plurality of domain classifications comprises:
generating, utilizing a machine-learning model, a first classification indicating the domain classification for the first electronic survey question and the second electronic survey question according to a first topic; and
generating, utilizing the machine-learning model, a second classification indicating an additional domain classification for a third electronic survey question of the one or more electronic surveys according to a second topic.

3. The computer-implemented method of claim 2, wherein determining the correspondence between the first electronic survey question and the second electronic survey question comprises:
determining, utilizing a natural language processing model, that the first electronic survey question and the second electronic survey question comprise semantically similar content based on words or phrases included in the first electronic survey question and the second electronic survey question; and
determining the correspondence in response to the first electronic survey question and the second electronic survey question comprising the semantically similar content and being mapped to the domain classification.

4. The computer-implemented method of claim 3, wherein determining the correspondence comprises determining, utilizing the natural language processing model, that the first electronic survey question and the second electronic survey question comprise the semantically similar content in response to determining that the first electronic survey question and the second electronic survey question are mapped the domain classification.

5. The computer-implemented method of claim 3, wherein determining the plurality of domain classifications comprises determining, utilizing the machine-learning model, that the first electronic survey question and the second electronic survey question are mapped to the domain classification in response to determining that the first electronic survey question and the second electronic survey question comprise the semantically similar content.

6. The computer-implemented method of claim 3, wherein modifying the electronic survey comprises selecting the first electronic survey question to include in the modified electronic survey in response to determining that the first electronic survey question and the second electronic survey question are mapped to the domain classification and comprise the semantically similar content.

7. The computer-implemented method of claim 3, wherein modifying the electronic survey comprises removing the second electronic survey question from the one or more electronic surveys in response to determining that the first electronic survey question and the second electronic survey question are mapped to the domain classification and comprise the semantically similar content.

8. The computer-implemented method of claim 2, wherein determining the plurality of domain classifications comprises:
determining that the first electronic survey question is mapped to the domain classification from a first electronic survey; and
determining that the second electronic survey question is mapped to the domain classification from a second electronic survey.

9. The computer-implemented method of claim 1, wherein providing the modified electronic survey comprises providing the first electronic survey question with the modified electronic survey and excluding the second electronic survey question from the modified electronic survey.

10. A system comprising:
one or more non-transitory computer readable media comprising one or more machine-learning models; and
at least one processor configured to cause the system to:
determine, utilizing the one or more machine-learning models, a plurality of domain classifications for a plurality of electronic survey questions in one or more electronic surveys;
determine, utilizing the one or more machine-learning models, semantic similarities of the plurality of electronic survey questions;
determine, based on the semantic similarities of the plurality of electronic survey questions, a correspondence between a first electronic survey question of the one or more electronic surveys mapped to a domain classification and a second electronic survey question of the one or more electronic surveys mapped to the domain classification;
responsive to a selection of an electronic survey of the one or more electronic surveys, modify the electronic survey based on the correspondence between the first electronic survey question and the second electronic survey question; and
provide the modified electronic survey for display at a respondent client device.

11. The system of claim 10, wherein the at least one processor is further configured to cause the system to determine the plurality of domain classifications by generating, utilizing the one or more machine-learning models, a classification indicating that the first electronic survey question and the second electronic survey question are mapped to the domain classification in response to determining that the first electronic survey question and the second electronic survey question correspond to a topic of the domain classification.

12. The system of claim 10, wherein the at least one processor is further configured to cause the system to determine the semantic similarities of the plurality of electronic survey questions by determining, utilizing a natural language processing model, semantic meanings of the plurality of electronic survey questions according to words or phrases in the plurality of electronic survey questions.

13. The system of claim 12, wherein the at least one processor is further configured to cause the system to determine the correspondence between the first electronic survey question and the second electronic survey question in response to determining that the first electronic survey question and the second electronic survey question are mapped to the domain classification and have a similar semantic meaning.

14. The system of claim 10, wherein the at least one processor is further configured to cause the system to determine the correspondence between the first electronic survey question and the second electronic survey question by:
generating a deduplication confidence score for the first electronic survey question and the second electronic survey question based on the domain classification and semantic similarities between the first electronic survey question and the second electronic survey question; and
determining the correspondence between the first electronic survey question and the second electronic survey question based on the deduplication confidence score.

15. The system of claim 10, wherein the at least one processor is further configured to cause the system to:
receive response data from one or more client devices in response to the modified electronic survey;
determine that the response data lacks a response to an electronic survey question of the modified electronic survey;
determine a loss based on the response data lacking the response to the electronic survey question; and
modify parameters of the one or more machine-learning models to classify the electronic survey question based on the loss.

16. The system of claim 10, wherein the at least one processor is further configured to cause the system to:
receive response data from a plurality of client devices in response to the modified electronic survey;
determine that an electronic survey question mapped to a first domain classification by the one or more machine-learning models is associated with a second domain classification based on the response data; and
modify parameters of the one or more machine-learning models to map the electronic survey question to the second domain classification.

17. The system of claim 10, wherein the at least one processor is further configured to cause the system to:
provide, for display at an administrator client device, an indication of a deduplicated electronic survey question corresponding to the modified electronic survey;
receive, from the administrator client device, feedback data indicating that the deduplicated electronic survey question was incorrectly deduplicated; and
modify parameters of the one or more machine-learning models based on the feedback data.

18. A non-transitory computer readable medium comprising instructions that, when executed by at least one processor, cause the at least one processor to:
determine, utilizing a classification machine-learning model, a plurality of domain classifications for a plurality of electronic survey questions in one or more electronic surveys;
determine, utilizing a natural language processing model, semantic similarities of the plurality of electronic survey questions based on words or phrases in the plurality of electronic survey questions;
determine, based on the semantic similarities of the plurality of electronic survey questions, a correspondence between a first electronic survey question of the one or more electronic surveys mapped to a domain classification and a second electronic survey question of the one or more electronic surveys mapped to the domain classification;
responsive to a selection of an electronic survey of the one or more electronic surveys, modify the electronic survey based on the correspondence between the first electronic survey question and the second electronic survey question by excluding the second electronic survey question from the electronic survey; and
provide the modified electronic survey for display at a respondent client device.

19. The non-transitory computer readable medium of claim 18, further comprising instructions that, when executed by the at least one processor, cause the at least one processor to determine the plurality of domain classifications by:
mapping, utilizing the classification machine-learning model, the first electronic survey question to the domain classification based on semantic content of the first electronic survey question; and
mapping, utilizing the classification machine-learning model, the second electronic survey question to the domain classification based on semantic content of the second electronic survey question.

20. The non-transitory computer readable medium of claim 18, further comprising instructions that, when executed by the at least one processor, cause the at least one processor to determine the correspondence between the first electronic survey question and the second electronic survey question by:
determining that the first electronic survey question and the second electronic survey question comprise similar semantic meanings; and
determining the correspondence between the first electronic survey question and the second electronic survey question in response to determining that the first electronic survey question and the second electronic survey question comprise similar semantic meanings and are mapped to the domain classification.
